(19) United States
(12) Patent Application Publication
(10) Pub. No.: US 2019/0280991 A1
(43) Pub. Date: Sep. 12, 2019

(54) QUALITY OF SERVICE TRAFFIC MANAGEMENT IN HIGH-SPEED PACKET PROCESSING SYSTEMS

(71) Applicant: Intel Corporation, Santa Clara, CA (US)

(72) Inventors: Jasvinder SINGH, Shannon (IE); Pablo DE LARA GUARCH, Shannon (IE); Kevin LAATZ, Limerick (IE); CIARA POWER, Tramore (IE); Greg CURRAN, Ballysheedy (IE); John J. BROWNE, Limerick (IE)

(21) Appl. No.: 16/414,502

(22) Filed: May 16, 2019

(51) Int. Cl. H04L 12/861; H04L 12/713; H04L 12/851

(52) U.S. Cl. CPC H04L 49/90; H04L 47/24; H04L 45/586

(57) ABSTRACT

At a network interface, received packets are classified according to priority level or traffic class. Based on an assigned priority level, a received packet can be allocated to use a descriptor queue associated with the assigned priority level. The descriptor queue can have an associated buffer region in which portions of received packets are stored. The length of the descriptor queue can be dependent on the priority level such that a highest priority descriptor queue can be longer than a lowest priority descriptor queue. The size of the buffer can be dependent on the priority level such that a highest priority level can be assigned a separate buffer space of different size than that assigned to a lower priority level. A polling rate for a descriptor queue can be configured based on a priority level such that a highest priority level descriptor queue can be polled more frequently than a polling of a lower priority level descriptor queue.

### TECHNICAL FIELD

Various examples described herein relate to techniques for processing received packets based on a priority level.

### BACKGROUND

As the number of devices connected to the Internet grows, increasing amounts of data and content are transmitted using wired and wireless network interfaces, switches, and routers, among others. As packet transmission rates increase, the speed at which packet processing is to take place has also increased. When a packet processing system is overwhelmed with packets for receive-side processing or transmit-side processing, the system can in some cases drop packets. Dropped packets are not received and may need to be re-sent, which can introduce additional latency and increase processing resources needed for packet transmission and receipt.

### BRIEF DESCRIPTION OF THE DRAWINGS

FIG. 1 depicts an example of an ingress traffic management packet input/output (I/O) system.

FIG. 2A depicts an example of a memory allocation and polling system.

FIG. 2B depicts an example of a memory allocation and polling system.

FIG. 2C depicts an example of an implementation of a virtual switch.

FIG. 3 depicts an example network interface controller, in accordance with some embodiments.

FIGS. 4A and 4B depict examples of memory allocations for one or more ingress ports.

FIG. 4C depicts an example of allocations of memory buffers for packets from multiple NICs.

FIGS. 5A and 5B depict configuration processes.

FIG. 6 depicts a process for processing received packets.

FIG. 7 depicts a system.

FIG. 8 depicts a switch.

FIG. 9 depicts an example of a data center.

### DETAILED DESCRIPTION

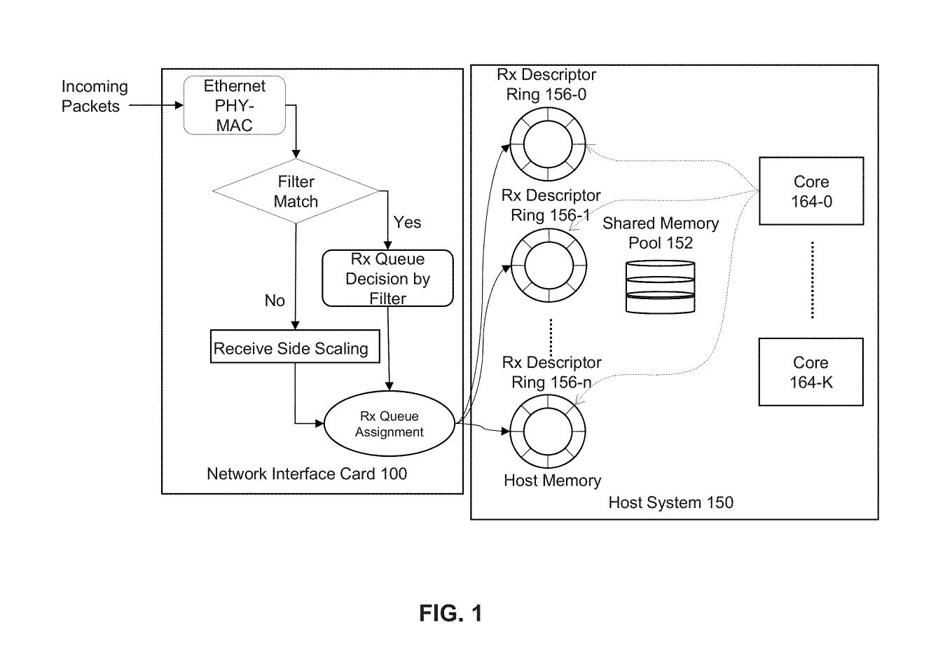

FIG. 1 depicts an example of an ingress traffic management packet input/output (I/O) system. Network interface card (NIC) 100 receives incoming packets. Ethernet physical layer and media access control layer processing is performed on the incoming packets. Incoming packets are classified using the NIC's receive side scaling (RSS) feature or using a decision by a filter. RSS allows for assignment of traffic flows to different descriptor queues using a hash calculation based on one or more portions of a packet. Based on the classification using RSS or a filter, packets are allocated to receive (Rx) descriptor queues and placed in shared memory pools allocated for storing the incoming packets in the host system. A central processing unit (CPU) core polls the descriptor queues uniformly in a round-robin manner to retrieve the packets for further processing. In such scenario, all the packets are treated the same regardless of their importance or priority. Packets may be dropped (e.g., discarded and not copied to host system 150) at the ingress interface (e.g., network interface controller 100) due to insufficient memory resources or insufficient CPU cycles assigned for polling the packet queues.

In a case of a high bandwidth network interface card, there is no guarantee that packets classified and assigned with different priorities using RSS or IEEE 802.1 compatible Data Center Bridging (DCB) do not get lost if the system resources are not provisioned correctly. The packet prioritization at the NIC may not completely address ingress traffic management by considering quality of service (QoS). For example, using a global memory resource (memory pool) in the CPU system can lead to drops (losses) of high priority packets when high-volume low-priority traffic consumes the entire allocated memory resources. As a result, high-priority packets might be dropped before the packet processing stage. Furthermore, multiple NIC queues, regardless of traffic type are served in a round robin manner by the CPU cores. As a result, high priority traffic with low-latency constraints (e.g. voice over IP (VoIP), video conferencing, online gaming, etc.) is treated the same as non-critical traffic.

Data Plane Development Kit (DPDK) is a set of data plane libraries and network interface controller drivers for packet processing. Typically, DPDK assigns a central processing unit (CPU) core to continuously poll multiple ingress queues (e.g., receive descriptor queues) to process received packets using the same core or another core. In this scenario, applications do not distinguish between the different types of traffic and assign memory and CPU resources irrespective of the traffic priority. In some cases, all packets have equal claim on available memory resources (e.g., queues and memory pools). In a typical scenario, a global memory resource (memory pool) is assigned to all driver descriptor queues (e.g., ring buffers) with the queue sizes being set to a same value. High-volume low-priority traffic can quickly consume the entire allocated memory resources, resulting in an indiscriminate drop of high priority network traffic (e.g., failure to store high priority network traffic). In some cases, high priority packets are dropped before the packet processing stage.

In the case of multiple receive descriptor queues per core, the queues are served by a core in a round robin manner, regardless of traffic type. As a result, high priority traffic with low-latency constraints (e.g., voice over IP (VoIP), video conferencing, online gaming, etc.) is treated the same as non-critical traffic (e.g., webpage traffic). Accordingly, high priority traffic may not be processed quickly enough and a user experience can be compromised.

Cisco IOS solution uses dedicated memory pools and sizes to handle congestion and overload conditions. The existing Cisco solution implements a policer to enforce the QoS strategy by rate-limiting the inbound traffic and dropping the packets that exceed the configured limits at the ingress interface. However, the Cisco IOS solution does not allocate memory resources (buffer pools size or descriptor queues sizes) based on traffic type or prioritize the CPU cycles for processing of packets of higher priority traffic.

To ensure adequate high performance, virtual switches/routers are increasingly relying on high speed packet I/O frameworks, e.g., Data Plane Development Kit (DPDK), which use poll mode infrastructure for sending and receiving packets as quickly as possible without using an interrupt based mechanism. In such polling mode packet I/O frameworks, while polling from hardware interfaces (e.g., network interface controllers or cards, accelerators, etc.) or software interfaces (virtual switches or virtual queues), the packet priority is not taken into account into setting the polling rate. As a result, the critical traffic (e.g., control/signaling packets, video packets) is treated the same as non-critical traffic which in turn can have a severe impact on the service quality of critical (higher priority) traffic.

Various embodiments provide for allocating available memory resources (e.g., queues, memory pools) based on packet priority so that various priority level packets receive separate dedicated queue and memory pool allocations. Various embodiments use network interface capabilities to classify the packets at line-rate. Classification of packets can be used to assign packets into descriptor queues according to packet priority. When a network interface is over-provisioned or overloaded, various embodiments attempt to reduce dropping of higher priority packets by allocating larger descriptor queues and more memory pool to higher priority packets. According to some embodiments, packet priority can be considered during packet polling such that more CPU cycles are allocated to poll for and process high priority traffic over lower priority traffic. An application, running on the CPU core, is able to poll descriptor queues using an appropriate scheduling mechanism such as weighted round robin, strict priority, and so forth.

Various embodiments provide a quality of service (QoS) ingress traffic management approach for high-speed packet input/output (I/O) systems. Various embodiments leverage the NIC capabilities to classify the packets, for example, at ingress line rate, and place them into prioritized descriptor queues. Descriptor queue size and associated buffer pools can be configured based on priority. Taking into account the different priorities of the queues, a CPU core or cores can perform non-uniform polling (e.g., non-uniform CPU resource allocation) using a scheduling mechanism such as weighted round robin, strict priority. A polling rate can be adjusted based on priority level or packets or volume of packets.

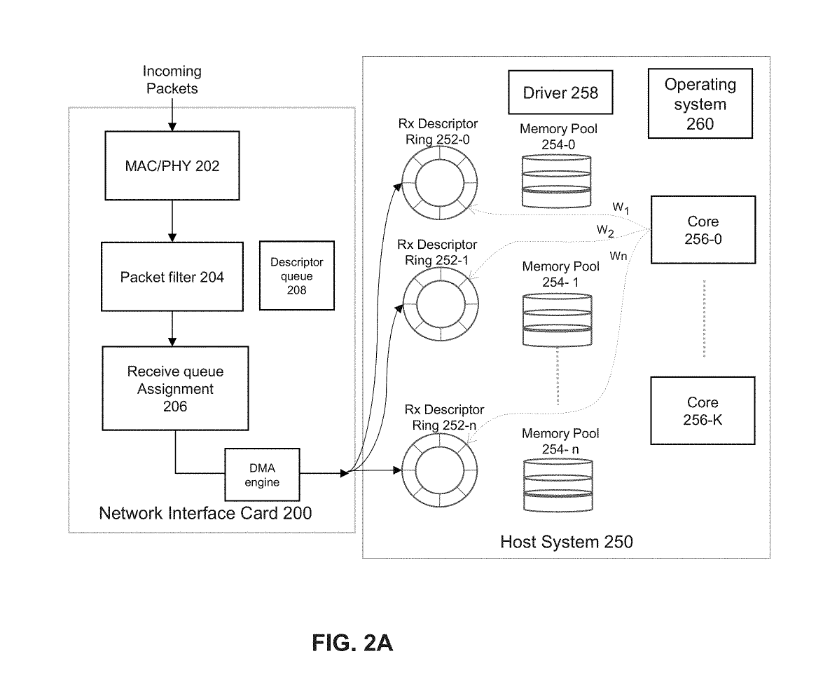

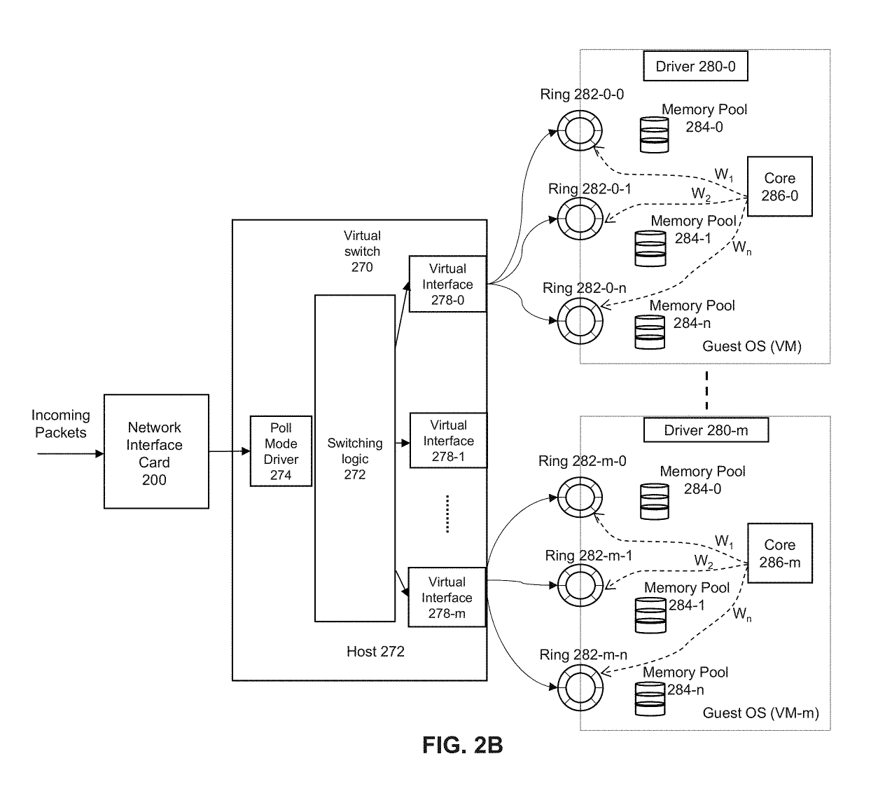

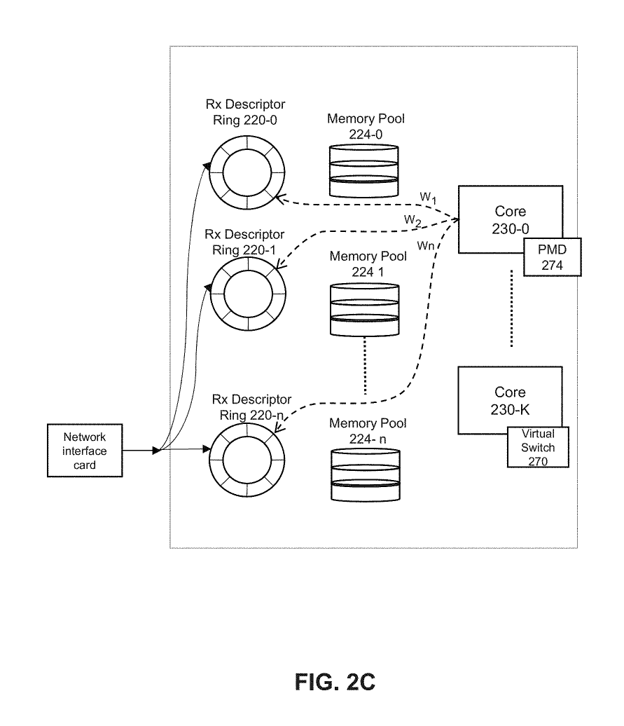

FIG. 2A depicts an example of a memory allocation and polling system. A virtual switch or virtual router, virtual gateway, network interface, endpoint receiver, router, switch, server, rack, or data center can use the system. In some examples, various embodiments can be used in connection with 5G Network Slicing whereby one or more virtual networks share a physical infrastructure can use the system to partition the platform and prioritize 5G Slice packets.

Network interface 200 can include a PHY/MAC layer processor 202 for performing physical layer and media access control (MAC) layer processing of incoming (received) packets. Packet filter 204 can perform packet classification based on content of the received packet header. Packet filter 204 can be implemented as a process or thread executed by one or more cores, an application specific integrated circuit (ASIC), field programmable gate array (FPGA), programmable control logic (PLC), or other processor. Packet filter 204 can decode content of a packet header to determine traffic class of the packets and receive queue assignment 206 can allocate the packet to a descriptor ring among receive (Rx) descriptor rings 252-0 to 252-n and memory pools 254-0 to 254-n based on the traffic classification. For example, traffic classification can be based on a virtual local access network (VLAN) tag (defined in IEEE 802.1Q) provided with a packet can define a packet priority. A 3-bit user priority field in the VLAN tag can be used to define a packet priority among 8 traffic classes. A receive descriptor ring 252 can be allocated for each traffic class.

Packet filter 204 and/or receive queue assignment logic 206 can use DCB and/or RSS features to provide for early packet priority determination at line-rate. In a case of a received packet with a VLAN tag, use of a DCB feature can determine the traffic class based on 3 bits user priority field in the tag. In other examples, if a received packet does not have a VLAN tag, packet filter 204 can determine packet priority based on one or more of a received packet's: differentiated services code point (DSCP) value in an internet protocol (IP) header of the received packet value, source IP address, destination IP address, or received port. For example, DSCP values (e.g., 6 bits) in an IPv4 header can define a traffic class (e.g., expedite, forward), type of traffic (e.g., user such as voice, video, web content, text messaging, and so forth), or packet priority level. In some examples, an application can indicate type or priority level of a packet (e.g., voice, video, web content, text messaging, and so forth).

If packet filter 204 and/or receive queue assignment logic 206 use DCB and/or RSS, a traffic class can be associated with X queues such that M traffic classes are distributed among M*X queues. In a case of 8 traffic classes, 128 queues of a NIC are divided into 8 groups (traffic classes), each having 16 queues (8 traffic classes*16 queues). A packet is assigned to one of the 128 queues. In a case of 4 traffic classes, 64 queues of the NIC will be used which will be divided into 4 groups, each having 16 queues (4 traffic classes * 16 queues). Thus, in this case, packets will be assigned to 64 queues.

If DCB is enabled and RSS is disabled, the queue is identified through a traffic class (TC) index. For 8 traffic classes, there will be 8 queues. For 4 traffic classes, 4 queues will be used.

After packet filter 204 and/or receive queue assignment logic 206 classify the incoming packets, NIC 200 queues the packets into multiple driver receive descriptor queues with different priorities.

A device driver can create descriptors and can manage the use and allocation of descriptors in descriptor queue 208. Descriptor queue 208 can be a region in NIC memory or system memory of host system 250 that includes or references descriptors. A device driver for NIC 200 (e.g., driver 258) can request transfer of descriptors from descriptor queue 208 to an allocated receive (Rx) descriptor ring 252-0 to 252-n. Rx descriptor rings 252-0 to 252-n can be configured to store descriptors associated with received packets based on traffic class. Memory pools 254-0 to 254-n can be configured to store packet header and/or payload of received packets associated with respective rings 252-0 to 252-n based on traffic class.

According to some embodiments, OS 260 can perform differentiated assignment of memory resources (e.g., memory pools, queue sizes) based on packet priority. For example, an application running on an OS in the host can configure sizes of the memory pools and queues through APIs. Rx descriptor rings 252-0 to 252-n and memory pool 254-0 to 254-n are allocated to priority levels such that ring 252-0 and memory pool 254-0 are allocated to a highest priority level and ring 252-n and memory pool 254-n is allocated to a lowest priority level.

For a traffic class, a size of a memory pool and number of receive descriptors and size of the receive descriptor queues can be configured based on traffic type as a fraction of total traffic. For example, a largest memory pool and highest number of receive descriptor queues can be assigned to a highest priority traffic if high priority traffic represents a significant fraction or highest portion of the overall traffic. A smallest memory pool and lowest number of receive descriptor queues can be assigned to a lowest priority traffic if the lowest priority traffic represents a lowest fraction of the overall traffic.

In some examples, the size of a highest priority ring (e.g., number of descriptors stored) can be the largest among priority rings and larger than a size of a lowest priority ring. The size of a highest priority memory pool can be the largest among memory pools and larger than a size of a lowest priority memory pool. In some examples, multiple receive (Rx) descriptor rings can be allocated to a priority level and multiple memory pools can be allocated to a priority level. For example, a highest priority level can be allocated multiple Rx descriptor rings and multiple memory pools.

By allocating separate descriptor rings and memory pools of an appropriate size to higher priority packets, the chances of low-priority high-volume traffic causing high priority packet drops and the global memory pool exhaustion is reduced. Furthermore, in the case of high-volume low-priority traffic, an overflow of the corresponding memory pool can at most cause the tail drop of low priority packets or a drop of the priority level of packet that is experiencing overflow without impacting higher priority packets. The high priority traffic will get routed to its respective memory pools, as it may not be affected by peaks in low or lower priority traffic.

CPU cores 256-0 to 256-K can be used to process packets associated with any of descriptor rings 252-0 to 252-n. A CPU core can apply any packet admission polling policy such as strict priority, weighted round robin, etc. A core's polling cycle can be adjusted to poll higher priority descriptor ring more frequently than a lower priority queue. Using strict priority policy, the packets will be polled from the queues and eventually, will enter into the system in the order of their priorities. For strict priority, the highest priority queue will be served first by the CPU core before polling the second highest priority queues and so on. Similarly, using weighted round robin, polling cycles will be allocated to the packets queues in proportion to weights assigned as per the priorities. For weighted round robin, polling cycles of the CPU core will be allocated to the different priority queues in proportion to their weight. Any custom packet admission polling policy can be used.

CPU cores 256-0 to 256-K can perform table lookup for next route/hop, and other packet processing operations. Processing of received packets can include one or more of: determination if a packet is valid (e.g., correct Ethernet type, correct checksum, correct IP Protocol type, valid layers 4-7 protocol type), determination of packet destination (e.g., next hop, destination queue), use of Data Plane Development Kit (DPDK) or OpenDataPlane to perform one or more of: IP Filter checks, flow table lookup, outgoing port selection using a forwarding table, packet decryption, packet encryption, denial of server protection, packet counting, billing, traffic management/conditioning, traffic shaping/traffic scheduling, packet marking/remarking, packet inspection of layers 4-7, or traffic load balancing/load distribution. Received packets and processed packets can be stored in host memory accessible to processing elements of host system 250.

A core can be an execution core or computational engine that is capable of executing instructions. A core can have access to its own cache and read only memory (ROM), or multiple cores can share a cache or ROM. Cores can be homogeneous and/or heterogeneous devices. Any type of inter-processor communication techniques can be used, such as but not limited to messaging, inter-processor interrupts (IPI), inter-processor communications, and so forth. Cores can be connected in any type of manner, such as but not limited to, bus, ring, or mesh. Cores can also include a system agent. System agent can include or more of a memory controller, a shared cache, a cache coherency manager, arithmetic logic units, floating point units, core or processor interconnects, or bus or link controllers. System agent can provide one or more of: direct memory access (DMA) engine connection, non-cached coherent master connection, data cache coherency between cores and arbitrates cache requests, or Advanced Microcontroller Bus Architecture (AMBA) capabilities.

In some embodiments, NIC 200 can perform inline IPSEC (e.g., packet decryption) before packet classification and classify packets after decryption. NIC 200 can also add deeper class of service packet classification L3-L7 and Layer 2.5 which can be used to classify the class of service of the packet. One or more receive descriptor queues and memory pools can be allocated to each packet classification.

Various embodiments can partition a cache of one or more cores when they process different priorities packets and based on the packet class of service. In either case, an amount of cache be allocated based on packet class of service. For example, per-core (or per task or per process) control over system L3 cache (LLC) occupancy can be used. The LLC can be shared among all cores on the CPU node. Cache ways of LLC can be logically partitioned using multiple Class of Service (CLOS). Thus, high priority packets can be allocated with a dedicated CLOS (number of cache ways) with no overlap with other CLOS that are assigned to other CPU tasks.

FIG. 2B depicts a simplified schematic of a memory allocation and polling system. In some examples, ingress traffic management can be implemented through priority queues, congestion handling using memory allocation, and a priority admission polling policy. Network interface card (NIC) 200 determines priority classifications of received packets. Virtual switch 270 can provide an interface between NIC 200 and a single host device or one or more virtual machines for transfer of packets to user space while bypassing a kernel. Virtual switch 270 can act as an intermediary between a NIC and one or more virtual machines for transfer of packets. Virtual switch 270 can route or forward received packets to a destination virtual machine. The virtual switch can provide a routing rule to the network interface to route a received packet header, packet payload, and/or descriptors associated with the VM to the provisioned queue. Virtual switch 270 can use ring buffers and memory pools as a packet transport interface between a NIC 200 and virtual machine (VM) or container. The virtual switch can be executed by a host or network interface or both. Examples of virtual switch 270 include Open vSwitch (OVS), vector packet processing (VPP), Cisco Nexus 1000V, VMware virtual switch, and Tungsten Fabric vRouter.

A destination VM can use virtual network functions (VNF) to process received packets and can be an implementation of a network function run in virtual machines (VMs). Virtual switch 270 can use a Data Plane Development Kit (DPDK) poll mode driver 274 to poll received packets from queues of NIC 200. Poll mode driver 274 can allocate received packets to descriptor rings and memory buffers according to priority level in a similar manner as that described with respect to host system 250 in FIG. 2A. For example, for a traffic class, a size of a memory pool and number of receive descriptors and size of the receive descriptor queues can be configured based on traffic type as a fraction of total traffic. For example, FIG. 2C depicts an example implementation of virtual switch 270 for allocation of packets from NIC 200 to descriptor rings 220-0 to 220-n and memory pools 224-0 to 224-n. As shown in FIG. 2C, virtual switch 270 can execute on a same or different core as that of poll mode driver 274.

Referring again to FIG. 2B, virtual switch 270 can determine a virtual machine to process the received packet and allocate the received packet to a virtual interface among virtual interfaces 278-0 to 278-m. For example, virtual switch 270 can identify a destination VM using switch logic (e.g., match action tables) to allocate the packet to the virtual interface associated with the destination virtual machine. A map action table can map a priority queue of virtual switch 270 to a VM and its destination priority queue. A virtual interface can be associated with a single VM or multiple VMs. The packet can be allocated to the same priority queue (e.g., virtio ring or simple ring buffer) of the destination VM via a virtual interface. Virtual interfaces 278-0 to 278-m can be implemented using a DPDK vhost-user and provides packets to a receive queue of a destination VM via Quick Emulator (QEMU) or virtio rings (bypassing the kernel). Virtual switch 270 can identify a destination VM and copy the packet into same priority queue of destination VM (e.g. using a DMA operation). A same number of priority queues can be allocated for each destination VM as a number of priority queues used by virtual switch 270.

The poll mode driver used by a virtual machine (VM) can poll for available packets via virtual interfaces 278-0 to 278-m. Switching logic in virtual switch 270 can determine the destination VM and priority ring. The driver in the destination VM will allocate from and free the descriptors to the memory pool associated with the priority ring. In some examples, a DMA copy can be made from a from virtual switch address space to destination VM address space for one or more of a descriptor or packet content to the same priority level queue and same priority level of memory buffer.

If virtual switch 270 does not receive a packet priority from NIC 200, then virtual switch 270 performs packet priority determination. Packet priority determination can be made by reading the PCP field of the VLAN packet or DSCP field of the IP packet. If NIC 200 does not perform packet classification, then virtual switch 270 can identify the packet priority and destination VM by reading it from the packet header and put the packet into appropriate priority queues in response to polls from a destination VM. Subsequently, a destination VM can employ a virtual network function (VNF) to apply congestion management and admission polling policy to access the packet and perform packet processing on the packet.

A virtual machine (VM) can be software that runs an operating system and one or more applications. The virtual machine is defined by specification, configuration files, virtual disk file, NVRAM setting file, and the log file and is backed by the physical resources of a host computing platform.

A container can a software package of applications, configurations and dependencies so the applications run reliably on one computing environment to another. Containers can share an operating system installed on the server platform and run as isolated processes.

A process can be any software that is executed by a computer (including executables, binaries, libraries, or any code). An example process is a VNF. Multiple processes can be executed within a VM or container.

Accordingly, various embodiments can provide for adjustment of ring priority and sizes, buffer sizes, and packet admission polling policy for use in virtual switch-host interfaces, NIC-host interfaces, or NIC packet processing accelerator-host interfaces.

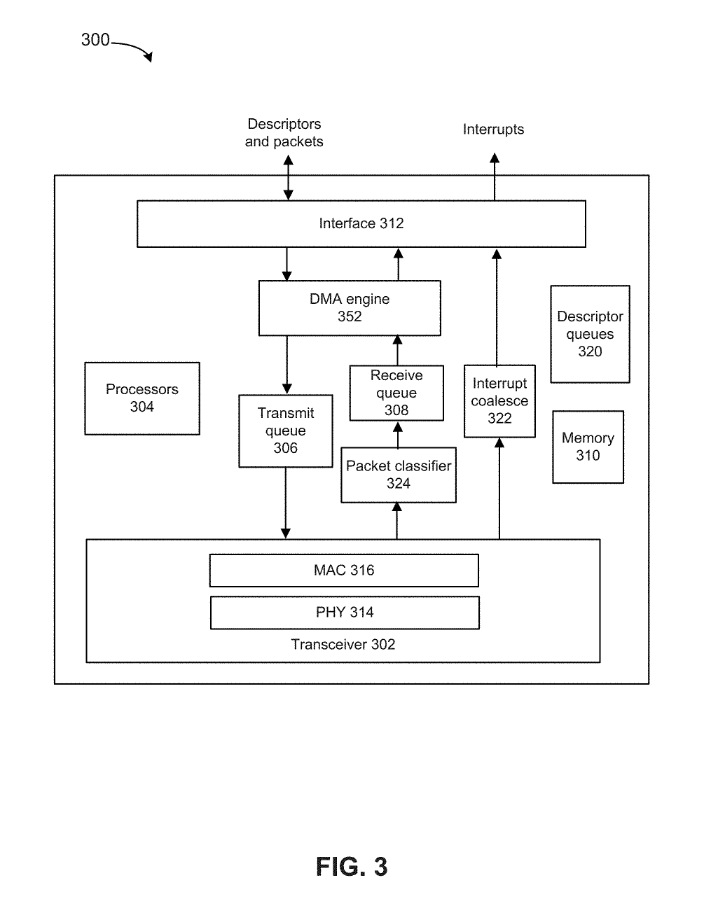

FIG. 3 depicts an example network interface controller, in accordance with some embodiments. Various embodiments can use the network interface or be used by the network interface. Network interface 300 can use transceiver 302, processors 304, transmit queue 306, receive queue 308, memory 310, and bus interface 312, and DMA engine 352. Transceiver 302 can be capable of receiving and transmitting packets in conformance with the applicable protocols such as Ethernet as described in IEEE 802.3, although other protocols may be used. Transceiver 302 can receive and transmit packets from and to a network via a network medium (not depicted). Transceiver 302 can include PHY circuitry 314 and media access control (MAC) circuitry 316. PHY circuitry 314 can include encoding and decoding circuitry (not shown) to encode and decode data packets according to applicable physical layer specifications or standards. MAC circuitry 316 can be configured to assemble data to be transmitted into packets, that include destination and source addresses along with network control information and error detection hash values. Processors 304 can be any a combination of a: processor, core, graphics processing unit (GPU), field programmable gate array (FPGA), application specific integrated circuit (ASIC), or other programmable hardware device that allow programming of network interface 300. For example, processors 304 can provide for identification of a resource to use to perform a workload and generation of a bitstream for execution on the selected resource. For example, a “smart network interface” can provide packet processing capabilities in the network interface using processors 304.

Packet classifier 324 can provide distribution of received packets for processing by multiple CPUs or cores using timeslot allocation described herein as well as by use of DCB and/or RSS. When packet classifier 324 uses RSS, packet classifier 324 can calculate a hash or make another determination based on contents of a received packet to determine which receive queue to associate with a received packet.

Interrupt coalesce 322 can perform interrupt moderation whereby network interface interrupt coalesce 322 waits for multiple packets to arrive, or for a time-out to expire, before generating an interrupt to host system to process received packet(s). Receive Segment Coalescing (RSC) can be performed by network interface 300 whereby portions of incoming packets are combined into segments of a packet. Network interface 300 provides this coalesced packet to an application.

Direct memory access (DMA) engine 352 can copy a packet header, packet payload, and/or descriptor directly from host memory to the network interface or vice versa, instead of copying the packet to an intermediate buffer at the host and then using another copy operation from the intermediate buffer to the destination buffer.

Memory 310 can be any type of volatile or non-volatile memory device and can store any queue or instructions used to program network interface 300. Transmit queue 306 can include data or references to data for transmission by network interface. Receive queue 308 can include data or references to data that was received by network interface from a network. Descriptor queues 320 can include descriptors that reference data or packets in transmit queue 306 or receive queue 308. Bus interface 312 can provide an interface with host device (not depicted). For example, bus interface 312 can be compatible with PCI, PCI Express, PCI-x, Serial ATA, and/or USB compatible interface (although other interconnection standards may be used).

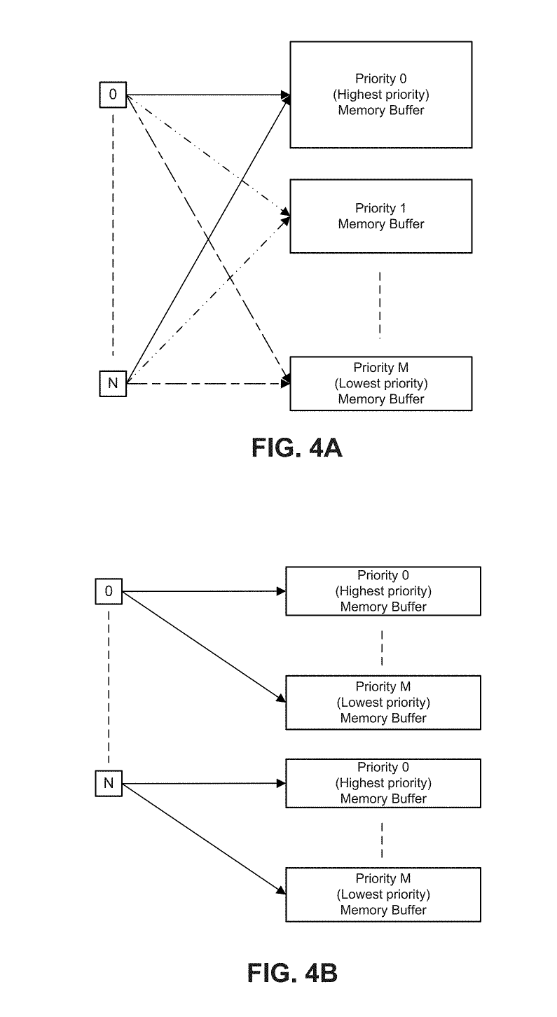

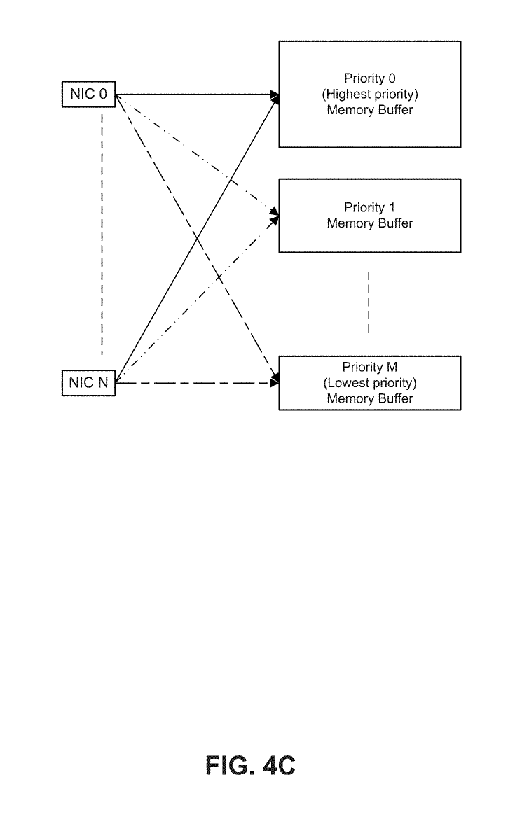

FIGS. 4A and 4B depict examples of memory allocations for one or more ingress ports. For example, as shown in FIG. 4A, a single NIC can have multiple receive ports and receive ports can be allocated to provide packets to one or more memory buffers. For example, priority 0 memory buffer can receive highest priority packets received from all ports 0 to N. Priority 1 memory buffer can receive a next highest priority level packets from all ports 0 to N. In a case that high priority traffic is a largest volume, a size of priority 0 memory buffer can be larger than priority 1 memory buffer, a size of priority 2 memory buffer, and so forth. However, a size of a memory buffer can be related to traffic volume. In a case where low priority traffic is high volume but high priority traffic is lower volume than that of low priority traffic, the size of the buffer for the low priority traffic can be larger than a size of a buffer for high priority traffic (not depicted). In some embodiments, the size of a priority memory buffer can be adjusted relative to the traffic volume. In some examples, DPDK lockless rings can be used to form memory buffers to resolve access to a same memory location.

FIG. 4B depicts an example manner of allocating packets from a receive port 0 to N to multiple memory buffers. A memory pool can be subdivided to store packets of priority level 0 from a port 0, packets of priority level 1 from a port 0, and so forth. The same or another memory pool can be subdivided to store packets of priority level 0 from a port 1, packets of priority level 1 from a port 1, and so forth. In some examples, DPDK lockless rings can be used to form memory buffers to resolve access to a same memory location.

In a case of multiple NICs, packets classified at the multiple NICs can be placed in NICs queues designated for different priorities packets. For example, the same priority packets from all the NICs, and regardless of receive port, can be stored in a memory pool designated for a particular priority level, in a similar manner as the example of FIG. 4A.

FIG. 4C depicts an example of allocations of memory buffers for packets from multiple NICs. For multiple NICs, prioritized memory pools can be allocated whereby packets of the same priority level from all NICS 0 to N are stored in a particular priority level memory buffer. For example, a packet of priority 0 from port 0 from NIC 1 are stored in priority 0 memory buffer. Likewise, a packet of priority 1 from port 0 from NIC 0 and a packet of priority 1 from port 1 from NIC 1 are stored in priority 1 memory buffer. In some embodiments, for the example of FIG. 4C, the highest priority packets correspond to the highest volume of traffic and accordingly a largest memory buffer is allocated to the highest priority packets. Conversely, the lowest priority packets correspond to the lowest volume of traffic and accordingly a smallest memory buffer is allocated to the lowest priority packets. In other examples, NIC 0, NIC 1 . . . NIC N can represent physical/virtual interfaces such as virtual switch-VM interface or NIC-VM interface.

CPU cores can use a standard or custom packet admission policy, and accordingly, can allocate their descriptor polling and packet processing cycles in proportion to the priorities of the packets from multiple NICs. For example, where priority 0 is a highest priority, one or more CPU cores can poll a descriptor queue for a priority 0 memory buffer and priority 0 memory buffer more frequently than polling a descriptor queue for a priority 4 memory buffer and priority 4 memory buffer. In some examples, CPU cores cycles can be first sub-divided among the ports and then further divided according to packet priorities. For example, core cycles can be evenly divided to poll for descriptors associated with packets from all ports and more clock cycles can be allocated for processing descriptors and packets associated with higher priority packets than for lower priority packets. A CPU core could poll the high priority queues first from all the ports, but in some instances, the higher priority queues have no packets. In that case, the CPU cycles reserved to process the high priority packets can be delegated to the next level priority queues and so on. Reallocating CPU cycles to other priority levels can potentially prevent the CPU from performing no packet processing during CPU cycles allocated for a priority level.

In some examples, CPU cycles can be allocated based on traffic volume for a priority level. If a second to lowest priority class receives the highest volume, a core of cores associated with the second to lowest priority class can be provisioned to poll most frequently for descriptors and the buffer associated with the second to lowest priority class.

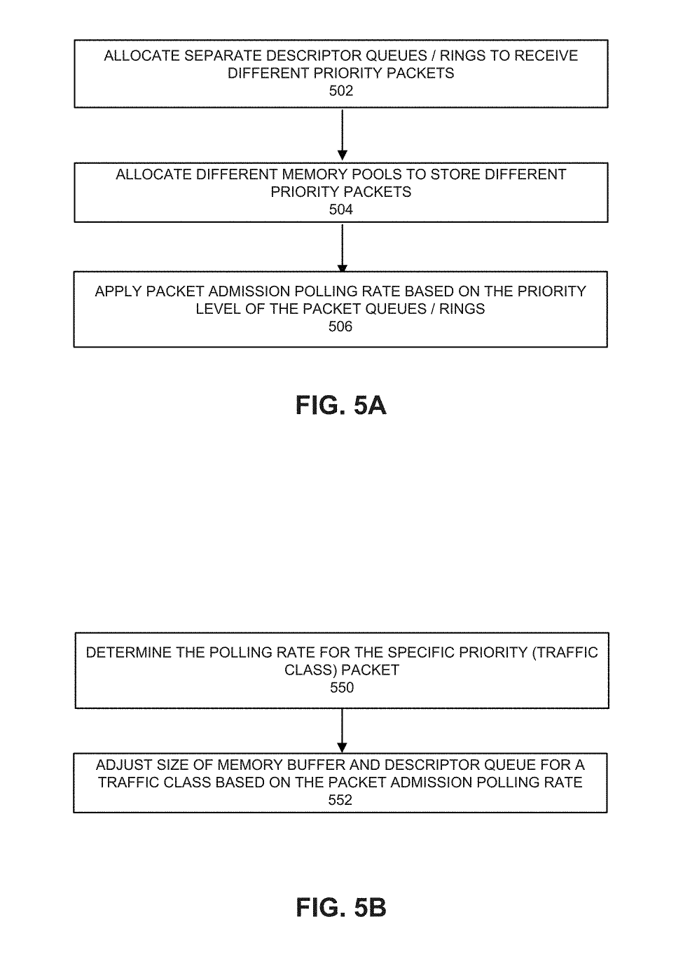

FIG. 5A depicts a configuration process. At 502, the process allocates receive descriptor queues/rings to receive packets of different priority levels. For example, a driver can allocate receive descriptor queues for use to receive completed descriptors from a network interface. For example, a first receive descriptor queue can be associated with a first (highest priority) level. A second receive descriptor queue can be associated with a second (next highest priority) level, and so forth. In some embodiments, for a priority level, a size of descriptor queue can depend on a volume of packets received during a time window.

At 504, the process can allocate different memory pools to store different priority packets. For example, a highest priority level receive descriptor queue can have an appropriate amount of memory for a buffer allocated. A next highest priority level receive descriptor queue can have appropriate amount of separate memory for an allocated buffer. In some embodiments, a highest priority level receives a largest size memory pool and descriptor queue. In some embodiments, for a priority level, the amount of memory allocated for a buffer can depend on a volume of packets received during a time window.

For example, a default size of a descriptor queue and memory buffer can be set based on a maximum expected receive rate for a traffic class. In some cases, when a maximum expected receive rate for the highest priority traffic class is a highest level and the receive rate for the lowest priority traffic class is a lowest level, the highest priority traffic can be allocated to the largest memory buffer and largest descriptor queue whereas a lowest priority traffic can be allocated the smallest memory buffer and smallest descriptor queue. However, in other cases, the sizes of buffers and descriptor queues for all traffic classes can be the same. An operating system can allocate buffers in system memory, a processor cache, or core cache.

At 506, the process can apply a polling rate based on the priority level of the associated packet queues/rings. For example, a core can be configured to poll a highest priority descriptor queue for completed descriptors most frequently or using a highest number of clock cycles. The core (or another core) can be configured to poll a next highest priority descriptor queue for completed descriptors at a next most frequency or number of clock cycles, and so forth. Accordingly, descriptors and associated packet content can be processed more frequently for a highest priority level than processing of descriptors and associated packet content for a next highest priority level. The software that controls polling rate of a core of descriptor queues could be embedded in the operating system (OS) as a separate function or could be part of the application level logic. A polling rate can be configured based on traffic volume for a traffic class such that a traffic class with the highest traffic volume can apply the highest polling rate, the traffic class with the next highest traffic volume can apply the next highest polling rate, and so forth.

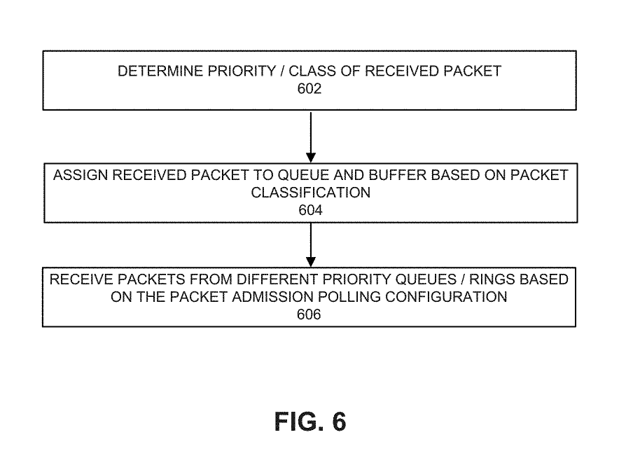

FIG. 5B depicts a configuration process. The process can be applied for one or more traffic classes after a configuration, for example using a process of FIG. 5A. At 550, the process determines a polling rate for a specific priority (e.g., traffic class) packet. At 552, the process adjusts a memory buffer size or descriptor queue size based on an applicable packet admission polling rate. For example, a highest admission polling rate can have a largest allocated memory buffer size and descriptor queue size. A lowest admission polling rate can have a lowest allocated memory buffer size and descriptor queue size. In other examples, the size of the memory buffer and descriptor queue size can depend on a received packet rate for a traffic class/priority of packet. A packet receive rate can be determined over one or more time durations. For example, if packet receive rate for a traffic class increases above a threshold for one or more time durations, the memory buffer size or descriptor queue size can be increased. For example, if packet receive rate for a traffic class decreases below a threshold for one or more time durations, the memory buffer size or descriptor queue size can be decreased and spare memory buffer allocation can be allocated to a memory buffer of another traffic class. The process can repeat during allocation of received traffic to buffers. For example, the process of FIG. 5B can commence or repeat during performance of a process of FIG. 6.

In some embodiments, the process of FIG. 5B can also be used to adjust a polling rate of a descriptor queue based on traffic volume for a traffic class such that a traffic class with the highest traffic volume (e.g., receive rate) can apply the highest polling rate, the traffic class with the next highest traffic volume can apply the next highest polling rate, and so forth.

FIG. 6 depicts a process for processing received packets. The process can be performed by a network interface and a core according to its polling rate. At 602, the process can determine a priority (e.g., classification) of a received packet. For example, traffic classification can be based on a virtual local access network (VLAN) tag (defined in IEEE 802.1Q) provided with a packet can define a packet priority. A 3-bit user priority field in the VLAN tag can be used to define a packet priority among 8 traffic classes. Priority of packet can be classified based on a differentiated services code point (DSCP) value in an internet protocol (IP) header of the received packet. In other examples, packet priority can be based on one or more of a received packet's: source IP address, destination IP address, or received port.

At 604, the process can assign the received packet to a descriptor queue and memory buffer based on the packet classification. Based on a determined priority level of the received packet, a descriptor queue is selected. In addition, the packet can be copied to a memory buffer associated with the descriptor queue using, for example, a direct memory access (DMA) copy operation.

At 606, the process can permit receipt of packets from the different priority descriptor queues based on the applicable polling admission configurations. For example, a core can process packets from a memory buffer based on available descriptors in a queue according to a prescribed polling rate. A core's polling cycle can be adjusted to poll a higher priority descriptor ring and packets in an associated memory pool more frequently than a lower priority queue and packets in an associated memory pool. In some embodiments, the polling rate for a traffic class can be adjusted based on the traffic volume for the traffic class over a time window.

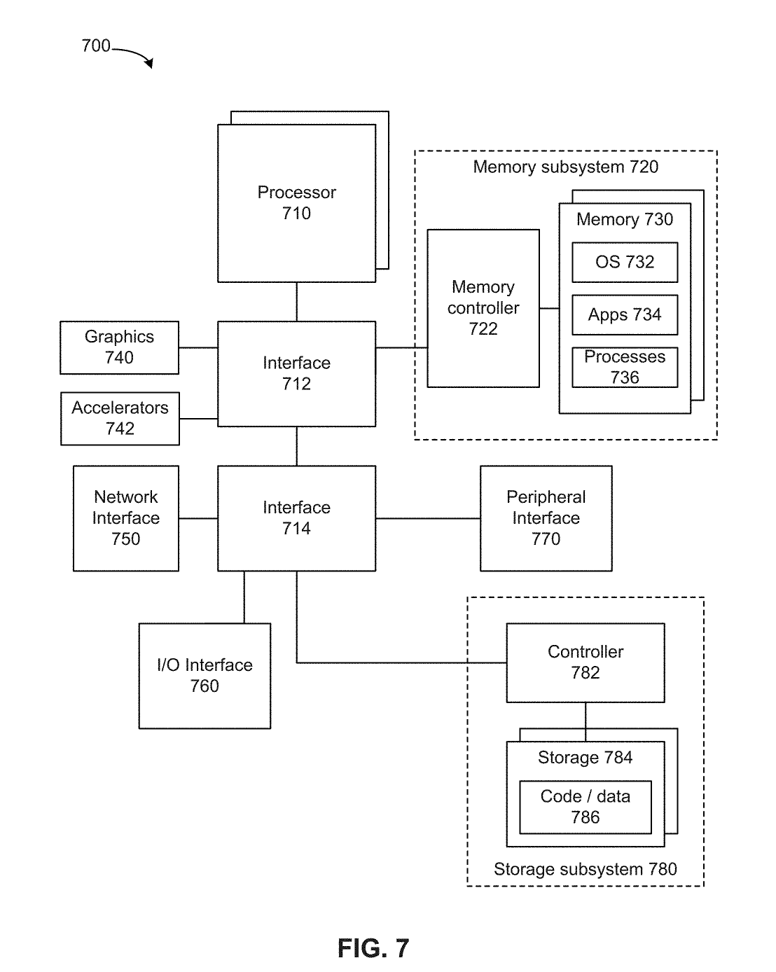

FIG. 7 depicts a system. The system can use embodiments described herein. System 700 includes processor 710, which provides processing, operation management, and execution of instructions for system 700. Processor 710 can include any type of microprocessor, central processing unit (CPU), graphics processing unit (GPU), processing core, or other processing hardware to provide processing for system 700, or a combination of processors. Processor 710 controls the overall operation of system 700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 700 includes interface 712 coupled to processor 710, which can represent a higher speed interface or a high throughput interface for system components that needs higher bandwidth connections, such as memory subsystem 720 or graphics interface components 740, or accelerators 742. Interface 712 represents an interface circuit, which can be a standalone component or integrated onto a processor die. Where present, graphics interface 740 interfaces to graphics components for providing a visual display to a user of system 700. In one example, graphics interface 740 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 740 generates a display based on data stored in memory 730 or based on operations executed by processor 710 or both. In one example, graphics interface 740 generates a display based on data stored in memory 730 or based on operations executed by processor 710 or both.

Accelerators 742 can be a fixed function offload engine that can be accessed or used by a processor 710. For example, an accelerator among accelerators 742 can provide compression (DC) capability, cryptography services such as public key encryption (PKE), cipher, hash/authentication capabilities, decryption, or other capabilities or services. In some embodiments, in addition or alternatively, an accelerator among accelerators 742 provides field select controller capabilities as described herein. In some cases, accelerators 742 can be integrated into a CPU socket (e.g., a connector to a motherboard or circuit board that includes a CPU and provides an electrical interface with the CPU). For example, accelerators 742 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 742 can provide multiple neural networks, processor cores, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 720 represents the main memory of system 700 and provides storage for code to be executed by processor 710, or data values to be used in executing a routine. Memory subsystem 720 can include one or more memory devices 730 such as read-only memory (ROM), flash memory, one or more varieties of random access memory (RAM) such as DRAM, or other memory devices, or a combination of such devices. Memory 730 stores and hosts, among other things, operating system (OS) 732 to provide a software platform for execution of instructions in system 700. Additionally, applications 734 can execute on the software platform of OS 732 from memory 730. Applications 734 represent programs that have their own operational logic to perform execution of one or more functions. Processes 736 represent agents or routines that provide auxiliary functions to OS 732 or one or more applications 734 or a combination. OS 732, applications 734, and processes 736 provide software logic to provide functions for system 700. In one example, memory subsystem 720 includes memory controller 722, which is a memory controller to generate and issue commands to memory 730. It will be understood that memory controller 722 could be a physical part of processor 710 or a physical part of interface 712. For example, memory controller 722 can be an integrated memory controller, integrated onto a circuit with processor 710.

While not specifically illustrated, it will be understood that system 700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus.

In one example, system 700 includes interface 714, which can be coupled to interface 712. In one example, interface 714 represents an interface circuit, which can include standalone components and integrated circuitry. In one example, multiple user interface components or peripheral components, or both, couple to interface 714. Network interface 750 provides system 700 the ability to communicate with remote devices (e.g., servers or other computing devices) over one or more networks. Network interface 750 can include an Ethernet adapter, wireless interconnection components, cellular network interconnection components, USB (universal serial bus), or other wired or wireless standards-based or proprietary interfaces. Network interface 750 can transmit data to a remote device, which can include sending data stored in memory. Network interface 750 can receive data from a remote device, which can include storing received data into memory. Various embodiments can be used in connection with network interface 750, processor 710, and memory subsystem 720.

In one example, system 700 includes one or more input/output (I/O) interface(s) 760. I/O interface 760 can include one or more interface components through which a user interacts with system 700 (e.g., audio, alphanumeric, tactile/touch, or other interfacing). Peripheral interface 770 can include any hardware interface not specifically mentioned above. Peripherals refer generally to devices that connect dependently to system 700. A dependent connection is one where system 700 provides the software platform or hardware platform or both on which operation executes, and with which a user interacts.

In one example, system 700 includes storage subsystem 780 to store data in a nonvolatile manner. In one example, in certain system implementations, at least certain components of storage 780 can overlap with components of memory subsystem 720. Storage subsystem 780 includes storage device(s) 784, which can be or include any conventional medium for storing large amounts of data in a nonvolatile manner, such as one or more magnetic, solid state, or optical based disks, or a combination. Storage 784 holds code or instructions and data 786 in a persistent state (i.e., the value is retained despite interruption of power to system 700). Storage 784 can be generically considered to be a “memory,” although memory 730 is typically the executing or operating memory to provide instructions to processor 710. Whereas storage 784 is nonvolatile, memory 730 can include volatile memory (i.e., the value or state of the data is indeterminate if power is interrupted to system 700). In one example, storage subsystem 780 includes controller 782 to interface with storage 784. In one example controller 782 is a physical part of interface 714 or processor 710 or can include circuits or logic in both processor 710 and interface 714.

A power source (not depicted) provides power to the components of system 700. More specifically, power source typically interfaces to one or multiple power supplies in system 700 to provide power to the components of system 700. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 700 can be implemented using interconnected compute sleds of processors, memories, storages, network interfaces, and other components. High speed interconnects can be used such as PCIe, Ethernet, or optical interconnects (or a combination thereof).

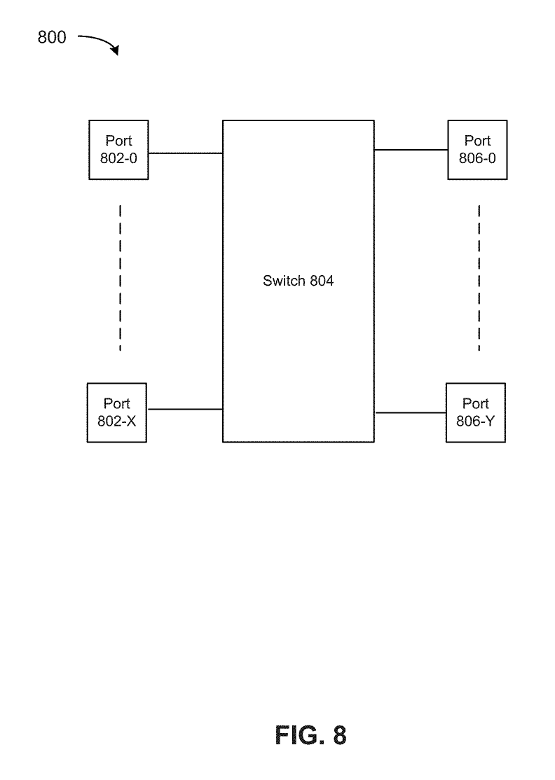

FIG. 8 depicts a switch. Various embodiments can be used in or with the switch of FIG. 8. Switch 804 can route packets or frames of any format or in accordance with any specification from any port 802-0 to 802-X to any of ports 806-0 to 806-Y (or vice versa). Any of ports 802-0 to 802-X can be connected to a network of one or more interconnected devices. Similarly, any of ports 806-0 to 806-X can be connected to a network of one or more interconnected devices. Switch 804 can decide which port to transfer packets or frames to using a table that maps packet characteristics with an associated output port. In addition, switch 904 can perform packet replication for forwarding of a packet or frame to multiple ports and queuing of packets or frames prior to transfer to an output port.

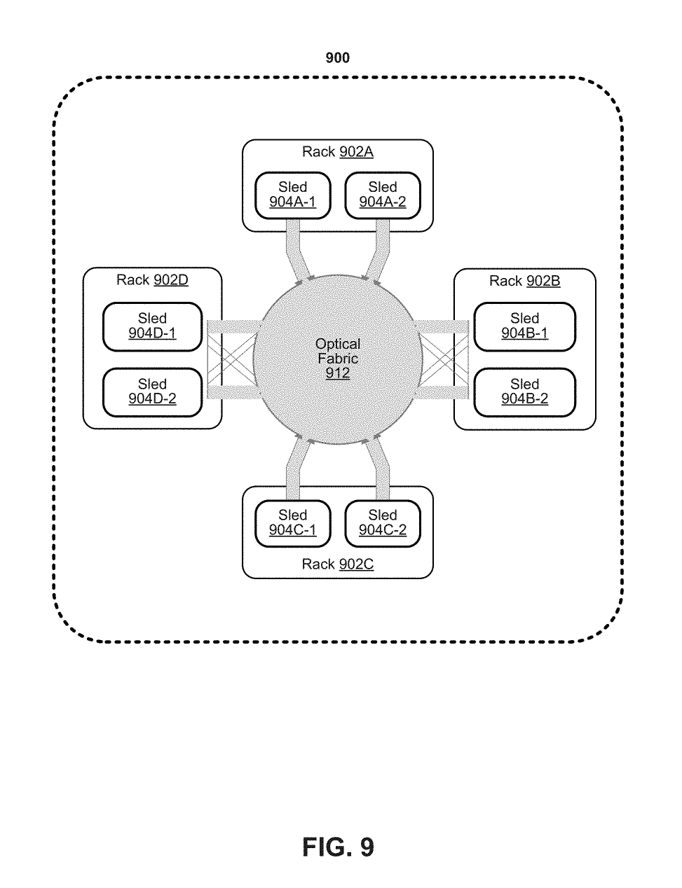

FIG. 9 depicts an example of a data center. Various embodiments can be used in or with the data center of FIG. 9. As shown in FIG. 9, data center 900 may include an optical fabric 912. Optical fabric 912 may generally include a combination of optical signaling media (such as optical cabling) and optical switching infrastructure via which any particular sled in data center 900 can send signals to (and receive signals from) the other sleds in data center 900. However, optical, wireless, and/or electrical signals can be transmitted using fabric 912. The signaling connectivity that optical fabric 912 provides to any given sled may include connectivity both to other sleds in a same rack and sleds in other racks. Data center 900 includes four racks 902A to 902D and racks 902A to 902D house respective pairs of sleds 904A-1 and 904A-2, 904B-1 and 904B-2, 904C-1 and 904C-2, and 904D-1 and 904D-2. Thus, in this example, data center 900 includes a total of eight sleds. Optical fabric 912 can provide sled signaling connectivity with one or more of the seven other sleds. For example, via optical fabric 9012, sled 904A-1 in rack 902A may possess signaling connectivity with sled 904A-2 in rack 902A, as well as the six other sleds 904B-1, 904B-2, 904C-1, 904C-2, 904D-1, and 904D-2 that are distributed among the other racks 902B, 902C, and 902D of data center 900. The embodiments are not limited to this example. For example, fabric 912 can provide optical and/or electrical signaling.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. It is noted that hardware, firmware and/or software elements may be collectively or individually referred to herein as “module,” “logic,” “circuit,” or “circuitry.”

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of steps may also be performed according to alternative embodiments. Furthermore, additional steps may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Example 1 includes a packet processing apparatus comprising: at least one memory and at least one processor communicatively coupled to the at least one memory, the at least one processor to: perform a virtual switch operation and: allocate a first queue in the at least one memory, the first queue associated with a first priority; allocate a second queue in the at least one memory, the second queue associated with a second priority that is lower than the first priority; allocate a first buffer associated with the first queue in the at least one memory; and allocate a second buffer associated with the second queue in the at least one memory, wherein: the first queue is larger than the second queue and the first buffer is larger than the second buffer; allocate a received packet to a queue and buffer based on its priority level and execute a virtual machine to process received packets, the virtual machine to apply priority-based admission polling policy for retrieving packets from queues and buffers associated with the virtual switch into priority queues and priority buffers associated with the virtual machine, wherein a priority-based packet admission polling policy is used, at least on part, on packet priority level.

Example 2 includes any example, wherein to apply priority-based admission polling, the at least one processor is to: poll the first queue for one or more descriptors according to a first rate and poll the second queue for one or more descriptors according to a second rate, the first rate greater than the second rate.

Example 3 includes any example, wherein to apply priority-based admission polling, the at least one processor is to: provision a first processor to poll the first queue for one or more descriptors according to a first rate and provision a second processor to poll the second queue for one or more descriptors according to a second rate, the first rate greater than the second rate.

Example 4 includes any example, wherein the virtual switch operation is an intermediary between a network interface and a virtual machine.

Example 5 includes any example, wherein the first buffer is associated with a first port of a network interface and the second buffer is associated with a second port of the network interface.

Example 6 includes any example, wherein the first buffer is associated with at least first and second ports of a network interface and the second buffer is associated with at least first and second ports of a second network interface.

Example 7 includes any example, wherein a cache size allocated to packets associated with the first queue is larger than a cache size allocated to packets associated with the second queue.

Example 8 includes any example and comprising in response to a network interface not providing a priority level of a received packet, the at least one processor is to process a received packet and determine a priority of the received packet based on a portion of a header of the received packet.

Example 9 includes any example, wherein the at least one processor to process a received packet and determine a priority of the received packet based on a portion of the header of the received packet is to apply one or more of: receive side scaling (RSS) or a Data Center Bridge.

Example 10 includes any example, wherein the portion of the header comprises one or more of: a VLAN header tag, differentiated services code point (DSCP) value, source IP address, destination IP address, or received port.

Example 11 includes any example and comprising one or more of: a network interface, a storage controller, a host computer, a server, a rack, a data center, virtual router, or virtual gateway.

Example 12 includes a method comprising: at a network interface, determining a packet priority based on a header of a packet; partitioning memory resources associated with a virtual machine to store the packet, wherein partitioning memory resources comprises allocating memory resources for highest priority packets based on packet volume and allocating memory resources for lowest priority packets based on packet volume; and provisioning a core to perform differentiated polling on memory resources for the virtual machine whereby the core polls memory resources associated with highest priority packets at a first rate and polls memory resources associated with lowest priority packets at a second rate, wherein the first rate is based on packet volume for the highest priority packets and the second rate is based on packet volume for the lowest priority packets.

Example 13 includes any example, wherein the header comprises one or more of: a VLAN header tag, differentiated services code point (DSCP) value, source IP address, destination IP address, or received port.

Example 14 includes any example, wherein determining a packet priority based on a header of a packet comprises applying one or more of receive side scaling (RSS) or a Data Center Bridge.

Example 15 includes any example, wherein memory resources comprise one or more of: memory or cache.

Example 16 includes any example, wherein: memory resources comprise a first buffer and a second buffer, the first buffer is associated with a first port of the network interface, and the second buffer is associated with a second port of the network interface.

Example 17 includes any example, wherein: memory resources comprise a first buffer and a second buffer, the first buffer is associated with at least first and second ports of the network interface, and the second buffer is associated with at least first and second ports of a second network interface.

Example 18 includes a system comprising: a network interface; at least one memory; and at least two cores, the at least two cores communicatively coupled to the network interface and the at least one memory, the at least two cores are to: form a first descriptor ring in a memory; form a second descriptor ring in a memory; form a first buffer associated with the first descriptor ring in a memory; form a second buffer associated with the second descriptor ring in a memory, wherein the first buffer is associated with a highest priority level packet and the second buffer is associated with a lowest priority level packet and the first buffer is larger than the second buffer;

allocate a received packet to the first or second buffer based on a priority level of the received packet; and poll for received packets according based on a priority level wherein a poll rate of polling for highest priority level packets is higher than a poll rate for lowest priority level packets.

Example 19 includes any example, wherein a core is to determine a priority level of the received packet based on one or more of: a VLAN header tag, differentiated services code point (DSCP) value, source IP address, destination IP address, or received port on the network interface.

Example 20 includes any example, wherein the first buffer is associated with a first port of a network interface and the second buffer is associated with a second port of the network interface.

Example 21 includes any example and comprises a second network interface, wherein the first buffer is associated with a first priority level packet from the network interface or the second network interface and the second buffer is associated with a second priority level packet from the network interface or the second network interface.

What is claimed is:

1. A packet processing apparatus comprising:
at least one memory and
at least one processor communicatively coupled to the at least one memory, the at least one processor to:
perform a virtual switch operation and:
allocate a first queue in the at least one memory, the first queue associated with a first priority;
allocate a second queue in the at least one memory, the second queue associated with a second priority that is lower than the first priority;
allocate a first buffer associated with the first queue in the at least one memory; and
allocate a second buffer associated with the second queue in the at least one memory, wherein:
the first queue is larger than the second queue and
the first buffer is larger than the second buffer;
allocate a received packet to a queue and buffer based on its priority level and
execute a virtual machine to process received packets, the virtual machine to apply priority-based admission polling policy for retrieving packets from queues and buffers associated with the virtual switch into priority queues and priority buffers associated with the virtual machine, wherein a priority-based packet admission polling policy is used, at least on part, on packet priority level.

2. The apparatus of claim 1, wherein to apply priority-based admission polling, the at least one processor is to:
poll the first queue for one or more descriptors according to a first rate and
poll the second queue for one or more descriptors according to a second rate, the first rate greater than the second rate.

3. The apparatus of claim 1, wherein to apply priority-based admission polling, the at least one processor is to:
provision a first processor to poll the first queue for one or more descriptors according to a first rate and
provision a second processor to poll the second queue for one or more descriptors according to a second rate, the first rate greater than the second rate.

4. The apparatus of claim 1, wherein the virtual switch operation is an intermediary between a network interface and a virtual machine.

5. The apparatus of claim 1, wherein the first buffer is associated with a first port of a network interface and the second buffer is associated with a second port of the network interface.

6. The apparatus of claim 1, wherein the first buffer is associated with at least first and second ports of a network interface and the second buffer is associated with at least first and second ports of a second network interface.

7. The apparatus of claim 1, wherein a cache size allocated to packets associated with the first queue is larger than a cache size allocated to packets associated with the second queue.

8. The apparatus of claim 1, comprising:
in response to a network interface not providing a priority level of a received packet, the at least one processor is to process a received packet and determine a priority of the received packet based on a portion of a header of the received packet.

9. The apparatus of claim 8, wherein the at least one processor to process a received packet and determine a priority of the received packet based on a portion of the header of the received packet is to apply one or more of: receive side scaling (RSS) or a Data Center Bridge.

10. The apparatus of claim 8, wherein the portion of the header comprises one or more of: a VLAN header tag, differentiated services code point (DSCP) value, source IP address, destination IP address, or received port.

11. The apparatus of claim 1, comprising one or more of: a network interface, a storage controller, a host computer, a server, a rack, a data center, virtual router, or virtual gateway.

12. A method comprising:
at a network interface, determining a packet priority based on a header of a packet;
partitioning memory resources associated with a virtual machine to store the packet, wherein partitioning memory resources comprises allocating memory resources for highest priority packets based on packet volume and allocating memory resources for lowest priority packets based on packet volume; and
provisioning a core to perform differentiated polling on memory resources for the virtual machine whereby the core polls memory resources associated with highest priority packets at a first rate and polls memory resources associated with lowest priority packets at a second rate, wherein the first rate is based on packet volume for the highest priority packets and the second rate is based on packet volume for the lowest priority packets.

13. The method of claim 12, wherein the header comprises one or more of: a VLAN header tag, differentiated services code point (DSCP) value, source IP address, destination IP address, or received port.

14. The method of claim 12, wherein determining a packet priority based on a header of a packet comprises applying one or more of receive side scaling (RSS) or a Data Center Bridge.

15. The method of claim 12, wherein memory resources comprise one or more of: memory or cache.

16. The method of claim 12, wherein:
memory resources comprise a first buffer and a second buffer,
the first buffer is associated with a first port of the network interface, and
the second buffer is associated with a second port of the network interface.

17. The method of claim 12, wherein:
memory resources comprise a first buffer and a second buffer,
the first buffer is associated with at least first and second ports of the network interface, and
the second buffer is associated with at least first and second ports of a second network interface.

18. A system comprising:
a network interface;
at least one memory; and
at least two cores, the at least two cores communicatively coupled to the network interface and the at least one memory, the at least two cores are to:
form a first descriptor ring in a memory;
form a second descriptor ring in a memory;
form a first buffer associated with the first descriptor ring in a memory;
form a second buffer associated with the second descriptor ring in a memory, wherein the first buffer is associated with a highest priority level packet and the second buffer is associated with a lowest priority level packet and the first buffer is larger than the second buffer;
allocate a received packet to the first or second buffer based on a priority level of the received packet; and
poll for received packets according based on a priority level wherein a poll rate of polling for highest priority level packets is higher than a poll rate for lowest priority level packets.

19. The system of claim 18, wherein a core is to determine a priority level of the received packet based on one or more of: a VLAN header tag, differentiated services code point (DSCP) value, source IP address, destination IP address, or received port on the network interface.

20. The system of claim 18, wherein the first buffer is associated with a first port of a network interface and the second buffer is associated with a second port of the network interface.

21. The system of claim 18, comprising a second network interface, wherein the first buffer is associated with a first priority level packet from the network interface or the second network interface and the second buffer is associated with a second priority level packet from the network interface or the second network interface.
